(19) United States
(12) Patent Application Publication
(10) Pub. No.: US 2026/0073449 A1
(43) Pub. Date: Mar. 12, 2026

(54) SYSTEM

(71) Applicant: SoftBank Group Corp., Tokyo (JP)

(72) Inventor: Mikio YAGI, Tokyo (JP)

(21) Appl. No.: 19/318,460

(22) Filed: Sep. 4, 2025

(30) Foreign Application Priority Data
Sep. 10, 2024 (JP) 2024-156286

(51) Int. Cl. G06Q 40/06; G16Y 20/30

(52) U.S. Cl. CPC G06Q 40/062; G06Q 40/067; G16Y 20/30

(57) ABSTRACT

The system according to the embodiment comprises a collection unit, a storage unit, an analysis unit, an acquisition unit, a provision unit, and an execution support unit. The collection unit collects energy consumption data. The storage unit stores the data collected by the collection unit in the Cloud. The analysis unit analyzes the data stored by the storage unit. The acquisition unit acquires the latest energy trends or investment destination information based on the data analyzed by the analysis unit. The provision unit provides a renewable energy investment proposal based on the information obtained by the acquisition unit. The execution support unit provides specific steps for executing the investment proposal provided by the provision unit.

### CROSS-REFERENCE TO RELATED APPLICATION

The present application claims priority to and incorporates by reference the entire contents of Japanese Patent Application No. 2024-156286 filed in Japan on Sep. 10, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In the prior art, there was a problem that it was difficult for companies to effectively utilize energy consumption data to invest in renewable energy.

### SUMMARY OF THE INVENTION

The system according to the embodiment comprises a collection unit, a storage unit, an analysis unit, an acquisition unit, a provision unit, and an execution support unit. The collection unit collects energy consumption data. The storage unit stores the data collected by the collection unit in the Cloud. The analysis unit analyzes the data stored by the storage unit. The acquisition unit acquires the latest energy trends or investment destination information based on the data analyzed by the analysis unit. The provision unit provides a renewable energy investment proposal based on the information obtained by the acquisition unit. The execution support unit provides specific steps for executing the investment proposal provided by the provision unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

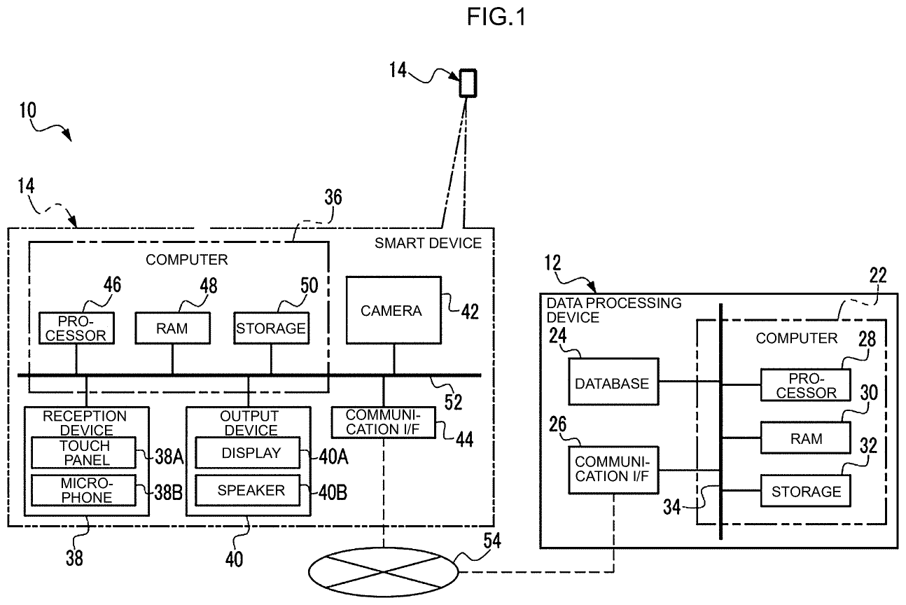

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

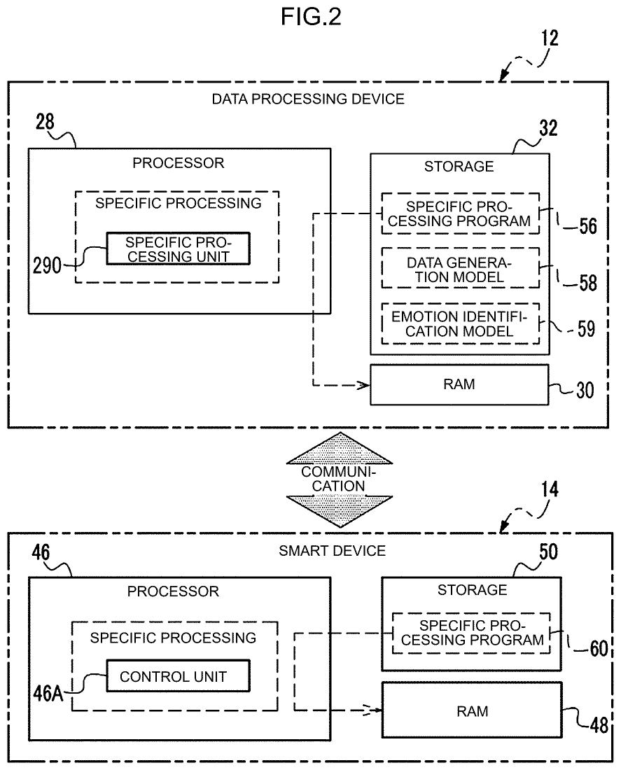

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The energy consumption optimization system according to the embodiment of the present invention is a system that optimizes a company's energy consumption and supports investment in renewable energy. This system constantly monitors a company's energy consumption using IoT devices and stores the data in the Cloud. Next, generative AI, based on this information and in combination with the latest energy trends and investment destination information, provides the company with the optimal renewable energy investment proposal. As a result, companies are supported in efficiently reducing CO2 and transitioning to a sustainable business model. For example, IoT devices installed in factories or office buildings collect data such as electricity consumption and gas usage in real time. This data is stored in the Cloud and later used for analysis by generative AI. The generative AI analyzes the energy consumption data stored in the Cloud, incorporates the latest energy trends and investment destination information, and generates the optimal renewable energy investment proposal for the company. For example, it may propose investments in renewable energy such as solar power or wind power. This proposal is made taking into account the company's energy consumption patterns and market trends. Furthermore, the generative AI provides specific steps for the company to execute the proposed investment plan. For example, it gives detailed advice on what equipment should be introduced and what contracts should be made. This enables companies to efficiently invest in renewable energy and achieve CO2 reduction. With this system, companies are supported in transitioning to a sustainable business model. For example, since energy cost reduction and environmental impact reduction can be expected, the company's competitiveness is improved. In addition, through investment in renewable energy, companies can fulfill their corporate social responsibility (CSR). Thus, the energy consumption optimization system can optimize a company's energy consumption and support investment in renewable energy.

The energy consumption optimization system according to the embodiment comprises a collection unit, a storage unit, an analysis unit, an acquisition unit, a provision unit, and an execution support unit. The collection unit collects the company's energy consumption data. For example, data such as electricity consumption and gas usage is collected in real time using IoT devices installed in factories or office buildings. The storage unit stores the data collected by the collection unit in the Cloud. For example, the collected data is stored in cloud services such as AWS (registered trademark), Google (registered trademark) Cloud, or Microsoft Azure (registered trademark). The analysis unit analyzes the energy consumption data stored in the Cloud using generative AI. For example, generative AI analyzes the energy consumption data using technologies such as deep learning and neural networks. The acquisition unit acquires the latest energy trends and investment destination information using generative AI. For example, it acquires information such as renewable energy price trends and the introduction status of new technologies. The provision unit provides the optimal renewable energy investment proposal by taking into account the company's energy consumption patterns and market trends using generative AI. For example, it proposes investment in solar power or wind power. The execution support unit provides specific steps for the company to execute the proposed investment plan using generative AI. For example, it gives detailed advice on what equipment should be introduced and what contracts should be made. In this way, the energy consumption optimization system according to the embodiment can optimize a company's energy consumption and support investment in renewable energy.

The collection unit can collect energy consumption data in real time using IoT devices installed in factories or office buildings. The collection unit, for example, collects energy consumption data in real time from factories or office buildings using IoT devices such as smart meters, sensors, and gateways. For example, a smart meter measures electricity consumption in real time and sends the data to the collection unit. Sensors can measure gas usage or temperature data and send the data to the collection unit. Furthermore, a gateway can integrate data collected from multiple IoT devices and send it to the collection unit. In this way, the collection unit can collect energy consumption data from factories or office buildings in real time. Some or all of the above-described processing in the collection unit may be performed using AI, or may be performed without using AI. For example, the collection unit can input data obtained from IoT devices into generative AI to optimize the timing and frequency of data collection.

The analysis unit can analyze energy consumption data stored in the Cloud using generative AI. The analysis unit, for example, analyzes energy consumption data stored in the Cloud using generative AI technologies such as deep learning and neural networks. For example, deep learning is a technology that builds neural networks with advanced pattern recognition capabilities by learning from large amounts of data. A neural network is a network of artificial neurons consisting of multiple layers, which processes input data and generates output. The analysis unit can use these technologies to improve the accuracy of energy consumption data analysis. For example, the analysis unit can analyze data using a generative AI model that takes energy consumption data as input and outputs consumption patterns or anomaly detection. In this way, the analysis unit can analyze energy consumption data stored in the Cloud using generative AI. Some or all of the above-described processing in the analysis unit may be performed using AI, or may be performed without using AI.

The acquisition unit can acquire the latest energy trends and investment destination information using generative AI. The acquisition unit, for example, acquires the latest energy trends and investment destination information using generative AI. For example, generative AI automatically collects information such as renewable energy price trends and the introduction status of new technologies and provides it to the acquisition unit. The acquisition unit generates the optimal renewable energy investment proposal for the company based on this information. For example, generative AI collects the latest energy trends from news articles, academic papers, government reports, etc. on the Internet. In addition, generative AI collects investment destination information such as the company's financial status and project progress and provides it to the acquisition unit. In this way, the acquisition unit can efficiently acquire the latest energy trends and investment destination information using generative AI. Some or all of the above-described processing in the acquisition unit may be performed using AI, or may be performed without using AI.

The provision unit can provide renewable energy investment proposals by taking into account the company's energy consumption patterns or market trends using generative AI. The provision unit, for example, provides the optimal renewable energy investment proposal by taking into account the company's energy consumption patterns and market trends using generative AI. For example, generative AI analyzes the company's energy consumption data and identifies patterns such as peak consumption and seasonal fluctuations. In addition, generative AI generates the optimal investment proposal by taking into account market trends such as energy price fluctuations and policy changes. For example, the provision unit may propose investment in renewable energy such as solar power, wind power, or biomass power generation. In this way, the provision unit can provide the optimal renewable energy investment proposal to the company. Some or all of the above-described processing in the provision unit may be performed using AI, or may be performed without using AI. For example, the provision unit provides the investment proposal generated by generative AI to the company and proposes the optimal investment proposal taking into account the company's energy consumption patterns and market trends.

The execution support unit can provide specific steps for the company to execute the proposed investment plan using generative AI. The execution support unit, for example, provides specific steps for the company to execute the proposed investment plan using generative AI. For example, generative AI gives detailed advice on what equipment should be introduced and what contracts should be made. For example, the execution support unit specifically proposes procedures for introducing solar power generation equipment or contract details for wind power generation projects. In addition, the execution support unit can also provide support such as methods for raising funds and project management. In this way, the execution support unit can provide specific steps for the company to efficiently execute investment in renewable energy. Some or all of the above-described processing in the execution support unit may be performed using AI, or may be performed without using AI. For example, the execution support unit provides the specific steps generated by generative AI to the company and supports the company in efficiently executing the proposed investment plan.

The collection unit can change the frequency of data collection based on specific time periods or seasons when collecting energy consumption data. The collection unit, for example, changes the frequency of data collection based on specific time periods or seasons when collecting energy consumption data. For example, since air conditioner usage increases in summer, the data collection frequency is increased. In addition, during nighttime hours when electricity consumption is low, the data collection frequency can be reduced. Furthermore, on weekends and holidays, the data collection frequency can be reduced compared to normal. In this way, the collection unit can obtain more accurate data by changing the data collection frequency based on specific time periods or seasons. Some or all of the above-described processing in the collection unit may be performed using AI, or may be performed without using AI. For example, the collection unit can have generative AI optimize the data collection frequency based on specific time periods or seasons.

The collection unit can add a function to detect abnormal consumption patterns and issue alerts when collecting energy consumption data. The collection unit, for example, adds a function to detect abnormal consumption patterns and issue alerts when collecting energy consumption data. For example, it detects a sudden surge in electricity consumption and issues an alert. In addition, if gas usage increases abnormally, it can issue an alert. Furthermore, if the consumption pattern deviates significantly from the normal pattern, it can issue an alert. In this way, the collection unit can enable prompt response by detecting abnormal consumption patterns and issuing alerts. Some or all of the above-described processing in the collection unit may be performed using AI, or may be performed without using AI. For example, the collection unit can have generative AI perform the detection of abnormal consumption patterns and alert generation.

The collection unit can collect data by taking into account geographic location information when collecting energy consumption data. The collection unit, for example, collects data by taking into account geographic location information when collecting energy consumption data. For example, it collects energy consumption data for each region based on the location information of factories. In addition, it can compare energy consumption data between urban and suburban areas based on the location information of office buildings. Furthermore, it can analyze energy consumption patterns in different regions based on geographic location information. In this way, the collection unit can analyze energy consumption patterns for each region by collecting data taking into account geographic location information. Some or all of the above-described processing in the collection unit may be performed using AI, or may be performed without using AI. For example, the collection unit can input geographic location information into generative AI and have generative AI perform data collection based on location information.

The collection unit can integrate and collect data from other IoT devices when collecting energy consumption data. The collection unit, for example, integrates and collects data from other IoT devices when collecting energy consumption data. For example, it integrates and collects data from IoT devices of lighting systems. In addition, it can integrate and collect data from IoT devices of HVAC systems. Furthermore, it can integrate and collect data from IoT devices of security systems. In this way, the collection unit can achieve more comprehensive data collection by integrating and collecting data from other IoT devices. Some or all of the above-described processing in the collection unit may be performed using AI, or may be performed without using AI. For example, the collection unit can input data from other IoT devices into generative AI and have generative AI perform integrated data collection.

The storage unit can determine the storage priority based on the importance of the data at the time of data storage. The storage unit, for example, determines the storage priority based on the importance of the data at the time of data storage. For example, important energy consumption data is stored with higher priority. Secondary data can be stored later. Furthermore, highly important data is stored immediately, while less important data can be stored later. In this way, the storage unit can store important data with higher priority by determining the storage priority based on the importance of the data. Some or all of the above-described processing in the storage unit may be performed using AI, or may be performed without using AI. For example, the storage unit can input the importance of the data into generative AI and have generative AI determine the storage priority based on importance.

The storage unit can apply different storage formats according to the type of data at the time of data storage. The storage unit, for example, applies different storage formats according to the type of data at the time of data storage. For example, electricity consumption data is stored in CSV format. Gas usage data can be stored in JSON format. Furthermore, temperature data can be stored in XML format. In this way, the storage unit can facilitate data management by applying different storage formats according to the type of data. Some or all of the above-described processing in the storage unit may be performed using AI, or may be performed without using AI. For example, the storage unit can input the type of data into generative AI and have generative AI apply the appropriate storage format according to the type.

The storage unit can determine the storage priority based on the submission timing of the data at the time of data storage. The storage unit, for example, determines the storage priority based on the submission timing of the data at the time of data storage. For example, recently submitted data is stored with higher priority. Older data can be stored later. Furthermore, data with a recent submission timing can be stored immediately. In this way, the storage unit can store data with a recent submission timing with higher priority by determining the storage priority based on the submission timing of the data. Some or all of the above-described processing in the storage unit may be performed using AI, or may be performed without using AI. For example, the storage unit can input the submission timing of the data into generative AI and have generative AI determine the storage priority based on submission timing.

The storage unit can adjust the order of storage based on the relevance of the data at the time of data storage. The storage unit, for example, adjusts the order of storage based on the relevance of the data at the time of data storage. For example, highly relevant data is stored with higher priority. Less relevant data can be stored later. Furthermore, the relevance of the data can be analyzed to determine the optimal storage order. In this way, the storage unit can store highly relevant data with higher priority by adjusting the order of storage based on the relevance of the data. Some or all of the above-described processing in the storage unit may be performed using AI, or may be performed without using AI. For example, the storage unit can input the relevance of the data into generative AI and have generative AI adjust the order of storage based on relevance.

The analysis unit can refer to past data to predict current data during analysis. The analysis unit, for example, refers to past data to predict current data during analysis. For example, it predicts current consumption based on past electricity consumption data. In addition, it can predict current usage based on past gas usage data. Furthermore, it can predict current temperature based on past temperature data. In this way, the analysis unit can more accurately predict current data by referring to past data. Some or all of the above-described processing in the analysis unit may be performed using AI, or may be performed without using AI. For example, the analysis unit can input past data into generative AI and have generative AI predict current data based on past data.

The analysis unit can apply different analysis algorithms for each data category during analysis. The analysis unit, for example, applies different analysis algorithms for each data category during analysis. For example, a time series analysis algorithm is applied to electricity consumption data. A regression analysis algorithm can be applied to gas usage data. Furthermore, a clustering algorithm can be applied to temperature data. In this way, the analysis unit can improve analysis accuracy by applying the optimal analysis algorithm for each data category. Some or all of the above-described processing in the analysis unit may be performed using AI, or may be performed without using AI. For example, the analysis unit can input the data category into generative AI and have generative AI apply different analysis algorithms for each category.

The analysis unit can determine the analysis priority based on the submission timing of the data during analysis. The analysis unit, for example, determines the analysis priority based on the submission timing of the data during analysis. For example, recently submitted data is analyzed with higher priority. Older data can be analyzed later. Furthermore, data with a recent submission timing can be analyzed immediately. In this way, the analysis unit can analyze data with a recent submission timing with higher priority by determining the analysis priority based on the submission timing of the data. Some or all of the above-described processing in the analysis unit may be performed using AI, or may be performed without using AI. For example, the analysis unit can input the submission timing of the data into generative AI and have generative AI determine the analysis priority based on submission timing.

The analysis unit can adjust the order of analysis based on the relevance of the data during analysis. The analysis unit, for example, adjusts the order of analysis based on the relevance of the data during analysis. For example, highly relevant data is analyzed with higher priority. Less relevant data can be analyzed later. Furthermore, the relevance of the data can be analyzed to determine the optimal analysis order. In this way, the analysis unit can analyze highly relevant data with higher priority by adjusting the order of analysis based on the relevance of the data. Some or all of the above-described processing in the analysis unit may be performed using AI, or may be performed without using AI. For example, the analysis unit can input the relevance of the data into generative AI and have generative AI adjust the order of analysis based on relevance.

The acquisition unit can update the latest energy trends in real time during acquisition. The acquisition unit, for example, updates the latest energy trends in real time during acquisition. For example, it acquires information on the latest solar power generation technology in real time. In addition, it can acquire information on the latest wind power generation technology in real time. Furthermore, it can acquire information on the latest biomass energy technology in real time. In this way, the acquisition unit can always acquire the latest information by updating the latest energy trends in real time. Some or all of the above-described processing in the acquisition unit may be performed using AI, or may be performed without using AI. For example, the acquisition unit can input the latest energy trend information into generative AI and have generative AI perform real-time information updates.

The acquisition unit can evaluate the reliability of investment destination information during acquisition and preferentially acquire highly reliable information. The acquisition unit, for example, evaluates the reliability of investment destination information during acquisition and preferentially acquires highly reliable information. For example, it preferentially acquires highly reliable investment destination information. Less reliable investment destination information can be acquired later. Furthermore, the reliability of investment destination information can be evaluated to acquire the optimal information. In this way, the acquisition unit can preferentially acquire highly reliable information by evaluating the reliability of investment destination information. Some or all of the above-described processing in the acquisition unit may be performed using AI, or may be performed without using AI. For example, the acquisition unit can input the reliability of investment destination information into generative AI and have generative AI determine the priority of information acquisition based on reliability.

The acquisition unit can acquire information by taking into account geographic location information during acquisition. The acquisition unit, for example, acquires information by taking into account geographic location information during acquisition. For example, it acquires energy trend information for each region based on the location information of factories. In addition, it can compare energy trend information between urban and suburban areas based on the location information of office buildings. Furthermore, it can analyze energy trends in different regions based on geographic location information. In this way, the acquisition unit can analyze energy trends for each region by acquiring information taking into account geographic location information. Some or all of the above-described processing in the acquisition unit may be performed using AI, or may be performed without using AI. For example, the acquisition unit can input geographic location information into generative AI and have generative AI acquire information based on location information.

The acquisition unit can integrate and acquire information from other data sources during acquisition. The acquisition unit, for example, integrates and acquires information from other data sources during acquisition. For example, it integrates and acquires information from data sources of lighting systems. In addition, it can integrate and acquire information from data sources of HVAC systems. Furthermore, it can integrate and acquire information from data sources of security systems. In this way, the acquisition unit can achieve more comprehensive information collection by integrating and acquiring information from other data sources. Some or all of the above-described processing in the acquisition unit may be performed using AI, or may be performed without using AI. For example, the acquisition unit can input information from other data sources into generative AI and have generative AI perform integrated information acquisition.

The provision unit can adjust the level of detail of the investment proposal based on the company's energy consumption pattern at the time of provision. The provision unit, for example, adjusts the level of detail of the investment proposal based on the company's energy consumption pattern at the time of provision. For example, for companies with high energy consumption, a detailed investment proposal is provided. For companies with low energy consumption, a concise investment proposal can be provided. Furthermore, the energy consumption pattern can be analyzed to provide the optimal level of detail for the investment proposal. In this way, the provision unit can provide more appropriate investment proposals by adjusting the level of detail based on the company's energy consumption pattern. Some or all of the above-described processing in the provision unit may be performed using AI, or may be performed without using AI. For example, the provision unit can input the company's energy consumption pattern into generative AI and have generative AI adjust the level of detail of the investment proposal based on the consumption pattern.

The provision unit can propose different investment proposals according to the industry type or scale of the company at the time of provision. The provision unit, for example, proposes different investment proposals according to the industry type or scale of the company at the time of provision. For example, for manufacturing companies, it proposes investment in solar power generation. For service industry companies, it can propose investment in wind power generation. Furthermore, it can propose appropriate investment proposals according to the scale of the company. In this way, the provision unit can provide more appropriate investment proposals by proposing different investment proposals according to the industry type or scale of the company. Some or all of the above-described processing in the provision unit may be performed using AI, or may be performed without using AI. For example, the provision unit can input the industry type or scale of the company into generative AI and have generative AI propose investment proposals based on the industry type or scale.

The provision unit can determine the priority of provision based on the submission timing of the investment proposal at the time of provision. The provision unit, for example, determines the priority of provision based on the submission timing of the investment proposal at the time of provision. For example, investment proposals with a recent submission timing are provided with higher priority. Investment proposals with a distant submission timing can be provided later. Furthermore, the optimal provision order can be determined based on the submission timing. In this way, the provision unit can provide investment proposals with a recent submission timing with higher priority by determining the priority of provision based on the submission timing of the investment proposal. Some or all of the above-described processing in the provision unit may be performed using AI, or may be performed without using AI. For example, the provision unit can input the submission timing of the investment proposal into generative AI and have generative AI determine the priority of provision based on submission timing.

The provision unit can adjust the order of provision based on the relevance of the investment proposal at the time of provision. The provision unit, for example, adjusts the order of provision based on the relevance of the investment proposal at the time of provision. For example, highly relevant investment proposals are provided with higher priority. Less relevant investment proposals can be provided later. Furthermore, the relevance of the investment proposal can be analyzed to determine the optimal provision order. In this way, the provision unit can provide highly relevant investment proposals with higher priority by adjusting the order of provision based on the relevance of the investment proposal. Some or all of the above-described processing in the provision unit may be performed using AI, or may be performed without using AI. For example, the provision unit can input the relevance of the investment proposal into generative AI and have generative AI adjust the order of provision based on relevance.

The execution support unit can select the optimal support method by referring to the company's past investment history during execution support. The execution support unit, for example, selects the optimal support method by referring to the company's past investment history during execution support. For example, it selects the optimal support method based on past successful investment history. In addition, it can select a support method to avoid risks based on past failed investment history. Furthermore, it can analyze past investment history to select the optimal support method. In this way, the execution support unit can select the optimal support method by referring to the company's past investment history. Some or all of the above-described processing in the execution support unit may be performed using AI, or may be performed without using AI. For example, the execution support unit can input the company's past investment history into generative AI and have generative AI select the optimal support method based on the history.

The execution support unit can customize the means of support based on the company's current financial situation during execution support. The execution support unit, for example, customizes the means of support based on the company's current financial situation during execution support. For example, for companies with a good financial situation, aggressive investment support is provided. For companies with a tight financial situation, investment support with reduced risk can be provided. Furthermore, the financial situation can be analyzed to customize the optimal support means. In this way, the execution support unit can provide more appropriate support by customizing the means of support based on the company's financial situation. Some or all of the above-described processing in the execution support unit may be performed using AI, or may be performed without using AI. For example, the execution support unit can input the company's financial situation into generative AI and have generative AI customize the means of support based on the financial situation.

The execution support unit can select the optimal support method by taking into account the company's geographic location information during execution support. The execution support unit, for example, selects the optimal support method by taking into account the company's geographic location information during execution support. For example, it selects the optimal support method for each region based on the location information of factories. In addition, it can compare the optimal support methods between urban and suburban areas based on the location information of office buildings. Furthermore, it can analyze the optimal support methods for different regions based on geographic location information. In this way, the execution support unit can provide the optimal support method for each region by taking into account the company's geographic location information. Some or all of the above-described processing in the execution support unit may be performed using AI, or may be performed without using AI. For example, the execution support unit can input the company's geographic location information into generative AI and have generative AI select the optimal support method based on location information.

The execution support unit can propose means of support by analyzing the company's social media activities during execution support. The execution support unit, for example, proposes means of support by analyzing the company's social media activities during execution support. For example, it proposes the optimal means of support based on the company's reputation on social media. In addition, it can analyze the company's activities on social media and customize the means of support. Furthermore, it can propose means of support by taking into account the company's influence on social media. In this way, the execution support unit can propose the optimal means of support by analyzing the company's social media activities. Some or all of the above-described processing in the execution support unit may be performed using AI, or may be performed without using AI. For example, the execution support unit can input the company's social media activities into generative AI and have generative AI propose means of support based on the activities.

The system according to the embodiment is not limited to the above-described examples, and various modifications are possible, for example, as follows.

The analysis unit can detect anomalies by comparing the company's energy consumption data with past energy consumption data during analysis. For example, if there is a sudden increase in consumption compared to past data, it can be detected as an anomaly and an alert can be issued. In addition, if the consumption pattern changes significantly compared to past data, it can also be detected as an anomaly. Furthermore, based on the results of anomaly detection, specific countermeasures can be provided to the company. In this way, the analysis unit can detect anomalies by comparing the company's energy consumption data with past data and support prompt response.

The collection unit can adjust the timing of data collection by taking into account the company's production schedule and operating status when collecting energy consumption data. For example, during peak production hours, the data collection frequency is increased, and during periods of low operation, the data collection frequency is decreased. In addition, if a specific production line is stopped, data collection for that line can be temporarily suspended. Furthermore, the optimal timing for data collection can be automatically adjusted based on the company's production schedule. In this way, the collection unit can optimize the timing of data collection according to the company's production schedule and operating status.

The analysis unit can evaluate cost efficiency by linking energy consumption data with the company's financial data during analysis. For example, by combining energy consumption data and financial data, the effect of reducing energy costs can be evaluated. In addition, the efficiency of energy consumption can be analyzed by comparing it with financial indicators. Furthermore, the impact of energy consumption improvements on the company's financial situation can be predicted. In this way, the analysis unit can evaluate the company's cost efficiency and propose improvement measures by linking energy consumption data with financial data.

The acquisition unit can acquire data by taking into account the company's environmental goals and CSR (corporate social responsibility) goals when acquiring energy consumption data. For example, data related to the company's CO2 reduction targets is preferentially acquired based on the targets set by the company. In addition, by acquiring data related to the company's CSR activities, the achievement status of environmental goals can be evaluated. Furthermore, the method of data acquisition can be optimized based on the company's environmental goals. In this way, the acquisition unit can acquire data according to the company's environmental and CSR goals and support the achievement of those goals.

The provision unit can customize the content provided according to the skill level of the company's employees when providing energy consumption data. For example, detailed technical information is provided to employees with expertise in energy management, while basic information is provided to general employees. In addition, the format of the information provided can be adjusted according to the skill level of the employees. Furthermore, training or educational programs can be proposed based on the skill level of the employees. In this way, the provision unit can customize the content provided according to the skill level of the company's employees and achieve effective information provision.

The following is a brief explanation of the process flow of Example 1 of the Embodiment.
Step 1: The collection unit collects the company's energy consumption data. For example, data such as electricity consumption and gas usage is collected in real time using IoT devices installed in factories or office buildings.
Step 2: The storage unit stores the data collected by the collection unit in the Cloud. For example, the collected data is stored in cloud services such as AWS, Google Cloud, or Microsoft Azure.
Step 3: The analysis unit analyzes the energy consumption data stored in the Cloud using generative AI. For example, generative AI analyzes the energy consumption data using technologies such as deep learning and neural networks.
Step 4: The acquisition unit acquires the latest energy trends and investment destination information using generative AI. For example, it acquires information such as renewable energy price trends and the introduction status of new technologies.
Step 5: The provision unit provides the optimal renewable energy investment proposal by taking into account the company's energy consumption patterns and market trends using generative AI. For example, it proposes investment in solar power or wind power.
Step 6: The execution support unit provides specific steps for the company to execute the proposed investment plan using generative AI. For example, it gives detailed advice on what equipment should be introduced and what contracts should be made.

### Example 2 of the Embodiment

The energy consumption optimization system according to the embodiment of the present invention is a system that optimizes a company's energy consumption and supports investment in renewable energy. This system constantly monitors a company's energy consumption using IT devices and stores the data in the Cloud. Next, generative AI, based on this information and in combination with the latest energy trends and investment destination information, provides the company with the optimal renewable energy investment proposal. As a result, companies are supported in efficiently reducing CO2 and transitioning to a sustainable business model. For example, IoT devices installed in factories or office buildings collect data such as electricity consumption and gas usage in real time. This data is stored in the Cloud and later used for analysis by generative AI. The generative AI analyzes the energy consumption data stored in the Cloud, incorporates the latest energy trends and investment destination information, and generates the optimal renewable energy investment proposal for the company. For example, it may propose investments in renewable energy such as solar power or wind power. This proposal is made taking into account the company's energy consumption patterns and market trends. Furthermore, the generative AI provides specific steps for the company to execute the proposed investment plan. For example, it gives detailed advice on what equipment should be introduced and what contracts should be made. This enables companies to efficiently invest in renewable energy and achieve CO2 reduction. With this system, companies are supported in transitioning to a sustainable business model. For example, since energy cost reduction and environmental impact reduction can be expected, the company's competitiveness is improved. In addition, through investment in renewable energy, companies can fulfill their corporate social responsibility (CSR). Thus, the energy consumption optimization system can optimize a company's energy consumption and support investment in renewable energy.

The energy consumption optimization system according to the embodiment comprises a collection unit, a storage unit, an analysis unit, an acquisition unit, a provision unit, and an execution support unit. The collection unit collects the company's energy consumption data. For example, data such as electricity consumption and gas usage is collected in real time using IoT devices installed in factories or office buildings. The storage unit stores the data collected by the collection unit in the Cloud. For example, the collected data is stored in cloud services such as AWS, Google Cloud, or Microsoft Azure. The analysis unit analyzes the energy consumption data stored in the Cloud using generative AI. For example, generative AI analyzes the energy consumption data using technologies such as deep learning and neural networks. The acquisition unit acquires the latest energy trends and investment destination information using generative AI. For example, it acquires information such as renewable energy price trends and the introduction status of new technologies. The provision unit provides the optimal renewable energy investment proposal by taking into account the company's energy consumption patterns and market trends using generative AI. For example, it proposes investment in solar power or wind power. The execution support unit provides specific steps for the company to execute the proposed investment plan using generative AI. For example, it gives detailed advice on what equipment should be introduced and what contracts should be made. In this way, the energy consumption optimization system according to the embodiment can optimize a company's energy consumption and support investment in renewable energy.

The collection unit can collect energy consumption data in real time using IoT devices installed in factories or office buildings. The collection unit, for example, collects energy consumption data in real time from factories or office buildings using IoT devices such as smart meters, sensors, and gateways. For example, a smart meter measures electricity consumption in real time and sends the data to the collection unit. Sensors can measure gas usage or temperature data and send the data to the collection unit. Furthermore, a gateway can integrate data collected from multiple IoT devices and send it to the collection unit. In this way, the collection unit can collect energy consumption data from factories or office buildings in real time. Some or all of the above-described processing in the collection unit may be performed using AI, or may be performed without using AI. For example, the collection unit can input data obtained from IoT devices into generative AI to optimize the timing and frequency of data collection.

The analysis unit can analyze energy consumption data stored in the Cloud using generative AI. The analysis unit, for example, analyzes energy consumption data stored in the Cloud using generative AI technologies such as deep learning and neural networks. For example, deep learning is a technology that builds neural networks with advanced pattern recognition capabilities by learning from large amounts of data. A neural network is a network of artificial neurons consisting of multiple layers, which processes input data and generates output. The analysis unit can use these technologies to improve the accuracy of energy consumption data analysis. For example, the analysis unit can analyze data using a generative AI model that takes energy consumption data as input and outputs consumption patterns or anomaly detection. In this way, the analysis unit can analyze energy consumption data stored in the Cloud using generative AI. Some or all of the above-described processing in the analysis unit may be performed using AI, or may be performed without using AI.

The acquisition unit can acquire the latest energy trends and investment destination information using generative AI. The acquisition unit, for example, acquires the latest energy trends and investment destination information using generative AI. For example, generative AI automatically collects information such as renewable energy price trends and the introduction status of new technologies and provides it to the acquisition unit. The acquisition unit generates the optimal renewable energy investment proposal for the company based on this information. For example, generative AI collects the latest energy trends from news articles, academic papers, government reports, etc. on the Internet. In addition, generative AI collects investment destination information such as the company's financial status and project progress and provides it to the acquisition unit. In this way, the acquisition unit can efficiently acquire the latest energy trends and investment destination information using generative AI. Some or all of the above-described processing in the acquisition unit may be performed using AI, or may be performed without using AI.

The provision unit can provide renewable energy investment proposals by taking into account the company's energy consumption patterns or market trends using generative AI. The provision unit, for example, provides the optimal renewable energy investment proposal by taking into account the company's energy consumption patterns and market trends using generative AI. For example, generative AI analyzes the company's energy consumption data and identifies patterns such as peak consumption and seasonal fluctuations. In addition, generative AI generates the optimal investment proposal by taking into account market trends such as energy price fluctuations and policy changes. For example, the provision unit may propose investment in renewable energy such as solar power, wind power, or biomass power generation. In this way, the provision unit can provide the optimal renewable energy investment proposal to the company. Some or all of the above-described processing in the provision unit may be performed using AI, or may be performed without using AI. For example, the provision unit provides the investment proposal generated by generative AI to the company and proposes the optimal investment proposal taking into account the company's energy consumption patterns and market trends.

The execution support unit can provide specific steps for the company to execute the proposed investment plan using generative AI. The execution support unit, for example, provides specific steps for the company to execute the proposed investment plan using generative AI. For example, generative AI gives detailed advice on what equipment should be introduced and what contracts should be made. For example, the execution support unit specifically proposes procedures for introducing solar power generation equipment or contract details for wind power generation projects. In addition, the execution support unit can also provide support such as methods for raising funds and project management. In this way, the execution support unit can provide specific steps for the company to efficiently execute investment in renewable energy. Some or all of the above-described processing in the execution support unit may be performed using AI, or may be performed without using AI. For example, the execution support unit provides the specific steps generated by generative AI to the company and supports the company in efficiently executing the proposed investment plan.

The collection unit can estimate the user's emotions and adjust the timing of energy consumption data collection based on the estimated user emotions. The collection unit, for example, estimates the user's emotions and adjusts the timing of energy consumption data collection based on the estimated user emotions. For example, if the user is feeling stressed, the collection timing is reduced and the frequency of data collection is lowered. If the user is relaxed, the collection timing is increased and the frequency of data collection is raised. Furthermore, if the user is in a hurry, the collection timing is optimized to quickly collect only the minimum necessary data. In this way, the collection unit can achieve more appropriate data collection by adjusting the data collection timing according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the collection unit may be performed using AI, or may be performed without using AI. For example, the collection unit can input the user's emotion data into generative AI and have generative AI optimize the data collection timing based on emotions.

The collection unit can change the frequency of data collection based on specific time periods or seasons when collecting energy consumption data. The collection unit, for example, changes the frequency of data collection based on specific time periods or seasons when collecting energy consumption data. For example, since air conditioner usage increases in summer, the data collection frequency is increased. In addition, during nighttime hours when electricity consumption is low, the data collection frequency can be reduced. Furthermore, on weekends and holidays, the data collection frequency can be reduced compared to normal. In this way, the collection unit can obtain more accurate data by changing the data collection frequency based on specific time periods or seasons. Some or all of the above-described processing in the collection unit may be performed using AI, or may be performed without using AI. For example, the collection unit can have generative AI optimize the data collection frequency based on specific time periods or seasons.

The collection unit can add a function to detect abnormal consumption patterns and issue alerts when collecting energy consumption data. The collection unit, for example, adds a function to detect abnormal consumption patterns and issue alerts when collecting energy consumption data. For example, it detects a sudden surge in electricity consumption and issues an alert. In addition, if gas usage increases abnormally, it can issue an alert. Furthermore, if the consumption pattern deviates significantly from the normal pattern, it can issue an alert. In this way, the collection unit can enable prompt response by detecting abnormal consumption patterns and issuing alerts. Some or all of the above-described processing in the collection unit may be performed using AI, or may be performed without using AI. For example, the collection unit can have generative AI perform the detection of abnormal consumption patterns and alert generation.

The collection unit can estimate the user's emotions and determine the priority of data to be collected based on the estimated user emotions. The collection unit, for example, estimates the user's emotions and determines the priority of data to be collected based on the estimated user emotions. For example, if the user is feeling stressed, only important data is collected with priority. If the user is relaxed, detailed data is collected with priority. Furthermore, if the user is in a hurry, data that can be collected quickly is collected with priority. In this way, the collection unit can collect more important data with priority by determining the priority of data according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the collection unit may be performed using AI, or may be performed without using AI. For example, the collection unit can input the user's emotion data into generative AI and have generative AI determine the priority of data based on emotions.

The collection unit can collect data by taking into account geographic location information when collecting energy consumption data. The collection unit, for example, collects data by taking into account geographic location information when collecting energy consumption data. For example, it collects energy consumption data for each region based on the location information of factories. In addition, it can compare energy consumption data between urban and suburban areas based on the location information of office buildings. Furthermore, it can analyze energy consumption patterns in different regions based on geographic location information. In this way, the collection unit can analyze energy consumption patterns for each region by collecting data taking into account geographic location information. Some or all of the above-described processing in the collection unit may be performed using AI, or may be performed without using AI. For example, the collection unit can input geographic location information into generative AI and have generative AI perform data collection based on location information.

The collection unit can integrate and collect data from other IoT devices when collecting energy consumption data. The collection unit, for example, integrates and collects data from other IoT devices when collecting energy consumption data. For example, it integrates and collects data from IoT devices of lighting systems. In addition, it can integrate and collect data from IoT devices of HVAC systems. Furthermore, it can integrate and collect data from IoT devices of security systems. In this way, the collection unit can achieve more comprehensive data collection by integrating and collecting data from other IoT devices. Some or all of the above-described processing in the collection unit may be performed using AI, or may be performed without using AI. For example, the collection unit can input data from other IoT devices into generative AI and have generative AI perform integrated data collection.

The storage unit can estimate the user's emotions and adjust the data storage method based on the estimated user emotions. The storage unit, for example, estimates the user's emotions and adjusts the data storage method based on the estimated user emotions. For example, if the user is feeling stressed, a simple storage method is provided. If the user is relaxed, detailed storage options can be provided. Furthermore, if the user is in a hurry, a method that allows quick storage can be provided. In this way, the storage unit can achieve more appropriate data storage by adjusting the data storage method according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the storage unit may be performed using AI, or may be performed without using AI. For example, the storage unit can input the user's emotion data into generative AI and have generative AI adjust the data storage method based on emotions.

The storage unit can determine the storage priority based on the importance of the data at the time of data storage. The storage unit, for example, determines the storage priority based on the importance of the data at the time of data storage. For example, important energy consumption data is stored with higher priority. Secondary data can be stored later. Furthermore, highly important data is stored immediately, while less important data can be stored later. In this way, the storage unit can store important data with higher priority by determining the storage priority based on the importance of the data. Some or all of the above-described processing in the storage unit may be performed using AI, or may be performed without using AI. For example, the storage unit can input the importance of the data into generative AI and have generative AI determine the storage priority based on importance.

The storage unit can apply different storage formats according to the type of data at the time of data storage. The storage unit, for example, applies different storage formats according to the type of data at the time of data storage. For example, electricity consumption data is stored in CSV format. Gas usage data can be stored in JSON format. Furthermore, temperature data can be stored in XML format. In this way, the storage unit can facilitate data management by applying different storage formats according to the type of data. Some or all of the above-described processing in the storage unit may be performed using AI, or may be performed without using AI. For example, the storage unit can input the type of data into generative AI and have generative AI apply the appropriate storage format according to the type.

The storage unit can estimate the user's emotions and adjust the data retention period based on the estimated user emotions. The storage unit, for example, estimates the user's emotions and adjusts the data retention period based on the estimated user emotions. For example, if the user is feeling stressed, a short retention period is proposed. If the user is relaxed, a long retention period can be proposed. Furthermore, if the user is in a hurry, the retention period can be optimized. In this way, the storage unit can achieve more appropriate data storage by adjusting the data retention period according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the storage unit may be performed using AI, or may be performed without using AI. For example, the storage unit can input the user's emotion data into generative AI and have generative AI adjust the data retention period based on emotions.

The storage unit can determine the storage priority based on the submission timing of the data at the time of data storage. The storage unit, for example, determines the storage priority based on the submission timing of the data at the time of data storage. For example, recently submitted data is stored with higher priority. Older data can be stored later. Furthermore, data with a recent submission timing can be stored immediately. In this way, the storage unit can store data with a recent submission timing with higher priority by determining the storage priority based on the submission timing of the data. Some or all of the above-described processing in the storage unit may be performed using AI, or may be performed without using AI. For example, the storage unit can input the submission timing of the data into generative AI and have generative AI determine the storage priority based on submission timing.

The storage unit can adjust the order of storage based on the relevance of the data at the time of data storage. The storage unit, for example, adjusts the order of storage based on the relevance of the data at the time of data storage. For example, highly relevant data is stored with higher priority. Less relevant data can be stored later. Furthermore, the relevance of the data can be analyzed to determine the optimal storage order. In this way, the storage unit can store highly relevant data with higher priority by adjusting the order of storage based on the relevance of the data. Some or all of the above-described processing in the storage unit may be performed using AI, or may be performed without using AI. For example, the storage unit can input the relevance of the data into generative AI and have generative AI adjust the order of storage based on relevance.

The analysis unit can estimate the user's emotions and adjust the analysis method based on the estimated user emotions. The analysis unit, for example, estimates the user's emotions and adjusts the analysis method based on the estimated user emotions. For example, if the user is feeling stressed, a simple analysis method is provided. If the user is relaxed, a detailed analysis method can be provided. Furthermore, if the user is in a hurry, a method that allows quick analysis can be provided. In this way, the analysis unit can achieve more appropriate data analysis by adjusting the analysis method according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the analysis unit may be performed using AI, or may be performed without using AI. For example, the analysis unit can input the user's emotion data into generative AI and have generative AI adjust the analysis method based on emotions.

The analysis unit can refer to past data to predict current data during analysis. The analysis unit, for example, refers to past data to predict current data during analysis. For example, it predicts current consumption based on past electricity consumption data. In addition, it can predict current usage based on past gas usage data. Furthermore, it can predict current temperature based on past temperature data. In this way, the analysis unit can more accurately predict current data by referring to past data. Some or all of the above-described processing in the analysis unit may be performed using AI, or may be performed without using AI. For example, the analysis unit can input past data into generative AI and have generative AI predict current data based on past data.

The analysis unit can apply different analysis algorithms for each data category during analysis. The analysis unit, for example, applies different analysis algorithms for each data category during analysis. For example, a time series analysis algorithm is applied to electricity consumption data. A regression analysis algorithm can be applied to gas usage data. Furthermore, a clustering algorithm can be applied to temperature data. In this way, the analysis unit can improve analysis accuracy by applying the optimal analysis algorithm for each data category. Some or all of the above-described processing in the analysis unit may be performed using AI, or may be performed without using AI. For example, the analysis unit can input the data category into generative AI and have generative AI apply different analysis algorithms for each category.

The analysis unit can estimate the user's emotions and determine the analysis priority based on the estimated user emotions. The analysis unit, for example, estimates the user's emotions and determines the analysis priority based on the estimated user emotions. For example, if the user is feeling stressed, the analysis of important data is prioritized. If the user is relaxed, the analysis of detailed data can be prioritized. Furthermore, if the user is in a hurry, the analysis of data that can be analyzed quickly can be prioritized. In this way, the analysis unit can analyze important data with priority by determining the analysis priority according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the analysis unit may be performed using AI, or may be performed without using AI. For example, the analysis unit can input the user's emotion data into generative AI and have generative AI determine the analysis priority based on emotions.

The analysis unit can determine the analysis priority based on the submission timing of the data during analysis. The analysis unit, for example, determines the analysis priority based on the submission timing of the data during analysis. For example, recently submitted data is analyzed with higher priority. Older data can be analyzed later. Furthermore, data with a recent submission timing can be analyzed immediately. In this way, the analysis unit can analyze data with a recent submission timing with higher priority by determining the analysis priority based on the submission timing of the data. Some or all of the above-described processing in the analysis unit may be performed using AI, or may be performed without using AI. For example, the analysis unit can input the submission timing of the data into generative AI and have generative AI determine the analysis priority based on submission timing.

The analysis unit can adjust the order of analysis based on the relevance of the data during analysis. The analysis unit, for example, adjusts the order of analysis based on the relevance of the data during analysis. For example, highly relevant data is analyzed with higher priority. Less relevant data can be analyzed later. Furthermore, the relevance of the data can be analyzed to determine the optimal analysis order. In this way, the analysis unit can analyze highly relevant data with higher priority by adjusting the order of analysis based on the relevance of the data. Some or all of the above-described processing in the analysis unit may be performed using AI, or may be performed without using AI. For example, the analysis unit can input the relevance of the data into generative AI and have generative AI adjust the order of analysis based on relevance.

The acquisition unit can estimate the user's emotions and determine the priority of information to be acquired based on the estimated user emotions. The acquisition unit, for example, estimates the user's emotions and determines the priority of information to be acquired based on the estimated user emotions. For example, if the user is feeling stressed, only important information is acquired with priority. If the user is relaxed, detailed information is acquired with priority. Furthermore, if the user is in a hurry, information that can be acquired quickly is acquired with priority. In this way, the acquisition unit can acquire important information with priority by determining the priority of information according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the acquisition unit may be performed using AI, or may be performed without using AI. For example, the acquisition unit can input the user's emotion data into generative AI and have generative AI determine the priority of information based on emotions.

The acquisition unit can update the latest energy trends in real time during acquisition. The acquisition unit, for example, updates the latest energy trends in real time during acquisition. For example, it acquires information on the latest solar power generation technology in real time. In addition, it can acquire information on the latest wind power generation technology in real time. Furthermore, it can acquire information on the latest biomass energy technology in real time. In this way, the acquisition unit can always acquire the latest information by updating the latest energy trends in real time. Some or all of the above-described processing in the acquisition unit may be performed using AI, or may be performed without using AI. For example, the acquisition unit can input the latest energy trend information into generative AI and have generative AI perform real-time information updates.

The acquisition unit can evaluate the reliability of investment destination information during acquisition and preferentially acquire highly reliable information. The acquisition unit, for example, evaluates the reliability of investment destination information during acquisition and preferentially acquires highly reliable information. For example, it preferentially acquires highly reliable investment destination information. Less reliable investment destination information can be acquired later. Furthermore, the reliability of investment destination information can be evaluated to acquire the optimal information. In this way, the acquisition unit can preferentially acquire highly reliable information by evaluating the reliability of investment destination information. Some or all of the above-described processing in the acquisition unit may be performed using AI, or may be performed without using AI. For example, the acquisition unit can input the reliability of investment destination information into generative AI and have generative AI determine the priority of information acquisition based on reliability.

The acquisition unit can estimate the user's emotions and adjust the display method of the information to be acquired based on the estimated user emotions. The acquisition unit, for example, estimates the user's emotions and adjusts the display method of the information to be acquired based on the estimated user emotions. For example, if the user is feeling stressed, a simple display method is provided. If the user is relaxed, a detailed display method can be provided. Furthermore, if the user is in a hurry, a method that allows quick display can be provided. In this way, the acquisition unit can achieve more appropriate information display by adjusting the display method of information according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the acquisition unit may be performed using AI, or may be performed without using AI. For example, the acquisition unit can input the user's emotion data into generative AI and have generative AI adjust the display method of information based on emotions.

The acquisition unit can acquire information by taking into account geographic location information during acquisition. The acquisition unit, for example, acquires information by taking into account geographic location information during acquisition. For example, it acquires energy trend information for each region based on the location information of factories. In addition, it can compare energy trend information between urban and suburban areas based on the location information of office buildings. Furthermore, it can analyze energy trends in different regions based on geographic location information. In this way, the acquisition unit can analyze energy trends for each region by acquiring information taking into account geographic location information. Some or all of the above-described processing in the acquisition unit may be performed using AI, or may be performed without using AI. For example, the acquisition unit can input geographic location information into generative AI and have generative AI acquire information based on location information.

The acquisition unit can integrate and acquire information from other data sources during acquisition. The acquisition unit, for example, integrates and acquires information from other data sources during acquisition. For example, it integrates and acquires information from data sources of lighting systems. In addition, it can integrate and acquire information from data sources of HVAC systems. Furthermore, it can integrate and acquire information from data sources of security systems. In this way, the acquisition unit can achieve more comprehensive information collection by integrating and acquiring information from other data sources. Some or all of the above-described processing in the acquisition unit may be performed using AI, or may be performed without using AI. For example, the acquisition unit can input information from other data sources into generative AI and have generative AI perform integrated information acquisition.

The provision unit can estimate the user's emotions and adjust the expression method of the investment proposal to be provided based on the estimated user emotions. The provision unit, for example, estimates the user's emotions and adjusts the expression method of the investment proposal to be provided based on the estimated user emotions. For example, if the user is feeling stressed, a simple and easy-to-understand expression method is provided. If the user is relaxed, an expression method including detailed information can be provided. Furthermore, if the user is in a hurry, an expression method that can be quickly understood can be provided. In this way, the provision unit can provide more appropriate investment proposals by adjusting the expression method of the investment proposal according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the provision unit may be performed using AI, or may be performed without using AI. For example, the provision unit can input the user's emotion data into generative AI and have generative AI adjust the expression method of the investment proposal based on emotions.

The provision unit can adjust the level of detail of the investment proposal based on the company's energy consumption pattern at the time of provision. The provision unit, for example, adjusts the level of detail of the investment proposal based on the company's energy consumption pattern at the time of provision. For example, for companies with high energy consumption, a detailed investment proposal is provided. For companies with low energy consumption, a concise investment proposal can be provided. Furthermore, the energy consumption pattern can be analyzed to provide the optimal level of detail for the investment proposal. In this way, the provision unit can provide more appropriate investment proposals by adjusting the level of detail based on the company's energy consumption pattern. Some or all of the above-described processing in the provision unit may be performed using AI, or may be performed without using AI. For example, the provision unit can input the company's energy consumption pattern into generative AI and have generative AI adjust the level of detail of the investment proposal based on the consumption pattern.

The provision unit can propose different investment proposals according to the industry type or scale of the company at the time of provision. The provision unit, for example, proposes different investment proposals according to the industry type or scale of the company at the time of provision. For example, for manufacturing companies, it proposes investment in solar power generation. For service industry companies, it can propose investment in wind power generation. Furthermore, it can propose appropriate investment proposals according to the scale of the company. In this way, the provision unit can provide more appropriate investment proposals by proposing different investment proposals according to the industry type or scale of the company. Some or all of the above-described processing in the provision unit may be performed using AI, or may be performed without using AI. For example, the provision unit can input the industry type or scale of the company into generative AI and have generative AI propose investment proposals based on the industry type or scale.

The provision unit can estimate the user's emotions and adjust the length of the investment proposal to be provided based on the estimated user emotions. The provision unit, for example, estimates the user's emotions and adjusts the length of the investment proposal to be provided based on the estimated user emotions. For example, if the user is feeling stressed, a short and concise investment proposal is provided. If the user is relaxed, a longer investment proposal including detailed explanations can be provided. Furthermore, if the user is in a hurry, a short investment proposal that can be quickly understood can be provided. In this way, the provision unit can provide more appropriate investment proposals by adjusting the length of the investment proposal according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the provision unit may be performed using AI, or may be performed without using AI. For example, the provision unit can input the user's emotion data into generative AI and have generative AI adjust the length of the investment proposal based on emotions.

The provision unit can determine the priority of provision based on the submission timing of the investment proposal at the time of provision. The provision unit, for example, determines the priority of provision based on the submission timing of the investment proposal at the time of provision. For example, investment proposals with a recent submission timing are provided with higher priority. Investment proposals with a distant submission timing can be provided later. Furthermore, the optimal provision order can be determined based on the submission timing. In this way, the provision unit can provide investment proposals with a recent submission timing with higher priority by determining the priority of provision based on the submission timing of the investment proposal. Some or all of the above-described processing in the provision unit may be performed using AI, or may be performed without using AI. For example, the provision unit can input the submission timing of the investment proposal into generative AI and have generative AI determine the priority of provision based on submission timing.

The provision unit can adjust the order of provision based on the relevance of the investment proposal at the time of provision. The provision unit, for example, adjusts the order of provision based on the relevance of the investment proposal at the time of provision. For example, highly relevant investment proposals are provided with higher priority. Less relevant investment proposals can be provided later. Furthermore, the relevance of the investment proposal can be analyzed to determine the optimal provision order. In this way, the provision unit can provide highly relevant investment proposals with higher priority by adjusting the order of provision based on the relevance of the investment proposal. Some or all of the above-described processing in the provision unit may be performed using AI, or may be performed without using AI. For example, the provision unit can input the relevance of the investment proposal into generative AI and have generative AI adjust the order of provision based on relevance.

The execution support unit can estimate the user's emotions and adjust the method of execution support based on the estimated user emotions. The execution support unit, for example, estimates the user's emotions and adjusts the method of execution support based on the estimated user emotions. For example, if the user is feeling stressed, a simple execution support method is provided. If the user is relaxed, a detailed execution support method can be provided. Furthermore, if the user is in a hurry, a method that allows quick execution can be provided. In this way, the execution support unit can provide more appropriate support by adjusting the method of execution support according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the execution support unit may be performed using AI, or may be performed without using AI. For example, the execution support unit can input the user's emotion data into generative AI and have generative AI adjust the method of execution support based on emotions.

The execution support unit can select the optimal support method by referring to the company's past investment history during execution support. The execution support unit, for example, selects the optimal support method by referring to the company's past investment history during execution support. For example, it selects the optimal support method based on past successful investment history. In addition, it can select a support method to avoid risks based on past failed investment history. Furthermore, it can analyze past investment history to select the optimal support method. In this way, the execution support unit can select the optimal support method by referring to the company's past investment history. Some or all of the above-described processing in the execution support unit may be performed using AI, or may be performed without using AI. For example, the execution support unit can input the company's past investment history into generative AI and have generative AI select the optimal support method based on the history.

The execution support unit can customize the means of support based on the company's current financial situation during execution support. The execution support unit, for example, customizes the means of support based on the company's current financial situation during execution support. For example, for companies with a good financial situation, aggressive investment support is provided. For companies with a tight financial situation, investment support with reduced risk can be provided. Furthermore, the financial situation can be analyzed to customize the optimal support means. In this way, the execution support unit can provide more appropriate support by customizing the means of support based on the company's financial situation. Some or all of the above-described processing in the execution support unit may be performed using AI, or may be performed without using AI. For example, the execution support unit can input the company's financial situation into generative AI and have generative AI customize the means of support based on the financial situation.

The execution support unit can estimate the user's emotions and determine the priority of execution support based on the estimated user emotions. The execution support unit, for example, estimates the user's emotions and determines the priority of execution support based on the estimated user emotions. For example, if the user is feeling stressed, important support is provided with priority. If the user is relaxed, detailed support can be provided with priority. Furthermore, if the user is in a hurry, support that can be executed quickly is provided with priority. In this way, the execution support unit can provide important support with priority by determining the priority of execution support according to the user's emotions. Emotion estimation is realized, for example, by using an emotion engine or generative AI as an emotion estimation function. Generative AI may be a text generative AI (e.g., LLM) or a multimodal generative AI, but is not limited to these examples. Some or all of the above-described processing in the execution support unit may be performed using AI, or may be performed without using AI. For example, the execution support unit can input the user's emotion data into generative AI and have generative AI determine the priority of execution support based on emotions.

The execution support unit can select the optimal support method by taking into account the company's geographic location information during execution support. The execution support unit, for example, selects the optimal support method by taking into account the company's geographic location information during execution support. For example, it selects the optimal support method for each region based on the location information of factories. In addition, it can compare the optimal support methods between urban and suburban areas based on the location information of office buildings. Furthermore, it can analyze the optimal support methods for different regions based on geographic location information. In this way, the execution support unit can provide the optimal support method for each region by taking into account the company's geographic location information. Some or all of the above-described processing in the execution support unit may be performed using AI, or may be performed without using AI. For example, the execution support unit can input the company's geographic location information into generative AI and have generative AI select the optimal support method based on location information.

The execution support unit can propose means of support by analyzing the company's social media activities during execution support. The execution support unit, for example, proposes means of support by analyzing the company's social media activities during execution support. For example, it proposes the optimal means of support based on the company's reputation on social media. In addition, it can analyze the company's activities on social media and customize the means of support. Furthermore, it can propose means of support by taking into account the company's influence on social media. In this way, the execution support unit can propose the optimal means of support by analyzing the company's social media activities. Some or all of the above-described processing in the execution support unit may be performed using AI, or may be performed without using AI. For example, the execution support unit can input the company's social media activities into generative AI and have generative AI propose means of support based on the activities.

The system according to the embodiment is not limited to the above-described examples, and various modifications are possible, for example, as follows.

The analysis unit can detect anomalies by comparing the company's energy consumption data with past energy consumption data during analysis. For example, if there is a sudden increase in consumption compared to past data, it can be detected as an anomaly and an alert can be issued. In addition, if the consumption pattern changes significantly compared to past data, it can also be detected as an anomaly. Furthermore, based on the results of anomaly detection, specific countermeasures can be provided to the company. In this way, the analysis unit can detect anomalies by comparing the company's energy consumption data with past data and support prompt response.

The collection unit can adjust the timing of data collection by taking into account the company's production schedule and operating status when collecting energy consumption data. For example, during peak production hours, the data collection frequency is increased, and during periods of low operation, the data collection frequency is decreased. In addition, if a specific production line is stopped, data collection for that line can be temporarily suspended. Furthermore, the optimal timing for data collection can be automatically adjusted based on the company's production schedule. In this way, the collection unit can optimize the timing of data collection according to the company's production schedule and operating status.

The analysis unit can evaluate cost efficiency by linking energy consumption data with the company's financial data during analysis. For example, by combining energy consumption data and financial data, the effect of reducing energy costs can be evaluated. In addition, the efficiency of energy consumption can be analyzed by comparing it with financial indicators. Furthermore, the impact of energy consumption improvements on the company's financial situation can be predicted. In this way, the analysis unit can evaluate the company's cost efficiency and propose improvement measures by linking energy consumption data with financial data.

The acquisition unit can acquire data by taking into account the company's environmental goals and CSR (corporate social responsibility) goals when acquiring energy consumption data. For example, data related to the company's CO2 reduction targets is preferentially acquired based on the targets set by the company. In addition, by acquiring data related to the company's CSR activities, the achievement status of environmental goals can be evaluated. Furthermore, the method of data acquisition can be optimized based on the company's environmental goals. In this way, the acquisition unit can acquire data according to the company's environmental and CSR goals and support the achievement of those goals.

The provision unit can customize the content provided according to the skill level of the company's employees when providing energy consumption data. For example, detailed technical information is provided to employees with expertise in energy management, while basic information is provided to general employees. In addition, the format of the information provided can be adjusted according to the skill level of the employees. Furthermore, training or educational programs can be proposed based on the skill level of the employees. In this way, the provision unit can customize the content provided according to the skill level of the company's employees and achieve effective information provision.

The execution support unit can estimate the emotions of the company's employees during execution support of energy consumption data and adjust the support method based on the estimated emotions. For example, if employees are feeling stressed, a simple and quick support method is provided. If employees are relaxed, a support method including detailed explanations can be provided. Furthermore, if employees are in a hurry, a support method that can be executed quickly can be provided. In this way, the execution support unit can adjust the support method according to the employees' emotions and provide effective support.

The collection unit can estimate the user's emotions during energy consumption data collection and customize the data collection interface based on the estimated emotions. For example, if the user is feeling stressed, a simple and intuitive interface is provided. If the user is relaxed, an interface that allows detailed settings can be provided. Furthermore, if the user is in a hurry, an interface that allows quick operation can be provided. In this way, the collection unit can customize the data collection interface according to the user's emotions and improve user convenience.

The analysis unit can estimate the user's emotions during energy consumption data analysis and adjust the display method of the analysis results based on the estimated emotions. For example, if the user is feeling stressed, a concise and to-the-point display method is provided. If the user is relaxed, detailed analysis results can be provided. Furthermore, if the user is in a hurry, a display method that can be quickly understood can be provided. In this way, the analysis unit can adjust the display method of the analysis results according to the user's emotions and promote user understanding.

The provision unit can estimate the user's emotions when providing energy consumption data and adjust the amount of information provided based on the estimated emotions. For example, if the user is feeling stressed, only the minimum necessary information is provided. If the user is relaxed, detailed information can be provided. Furthermore, if the user is in a hurry, information that can be quickly understood can be provided. In this way, the provision unit can adjust the amount of information provided according to the user's emotions and reduce the user's burden.

The execution support unit can estimate the user's emotions during execution support of energy consumption data and determine the priority of support based on the estimated emotions. For example, if the user is feeling stressed, important support is provided with priority. If the user is relaxed, detailed support can be provided with priority. Furthermore, if the user is in a hurry, support that can be executed quickly is provided with priority. In this way, the execution support unit can determine the priority of support according to the user's emotions and provide effective support.

The following is a brief explanation of the process flow of Example 2 of the Embodiment.
Step 1: The collection unit collects the company's energy consumption data. For example, data such as electricity consumption and gas usage is collected in real time using IoT devices installed in factories or office buildings.
Step 2: The storage unit stores the data collected by the collection unit in the Cloud. For example, the collected data is stored in cloud services such as AWS, Google Cloud, or Microsoft Azure.
Step 3: The analysis unit analyzes the energy consumption data stored in the Cloud using generative AI. For example, generative AI analyzes the energy consumption data using technologies such as deep learning and neural networks.
Step 4: The acquisition unit acquires the latest energy trends and investment destination information using generative AI. For example, it acquires information such as renewable energy price trends and the introduction status of new technologies.
Step 5: The provision unit provides the optimal renewable energy investment proposal by taking into account the company's energy consumption patterns and market trends using generative AI. For example, it proposes investment in solar power or wind power.
Step 6: The execution support unit provides specific steps for the company to execute the proposed investment plan using generative AI. For example, it gives detailed advice on what equipment should be introduced and what contracts should be made.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naïve Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the multiple elements including the above-described collection unit, storage unit, analysis unit, acquisition unit, provision unit, and execution support unit is implemented, for example, by at least one of the smart device 14 and the data processing apparatus 12. For example, the collection unit collects the company's energy consumption data in real time using the IoT device of the smart device 14. The storage unit stores the collected data in the cloud storage of the data processing apparatus 12. The analysis unit analyzes the energy consumption data stored in the cloud using generative AI by the specific processing unit 290 of the data processing apparatus 12. The acquisition unit acquires the latest energy trends and investment destination information by the specific processing unit 290 of the data processing apparatus 12. The provision unit provides the optimal renewable energy investment proposal to the company by the specific processing unit 290 of the data processing apparatus 12. The execution support unit provides specific steps for the company to execute the proposed investment plan by the specific processing unit 290 of the data processing apparatus 12. The correspondence between each unit and the device or control unit is not limited to the above examples and various modifications are possible.

### Second Embodiment

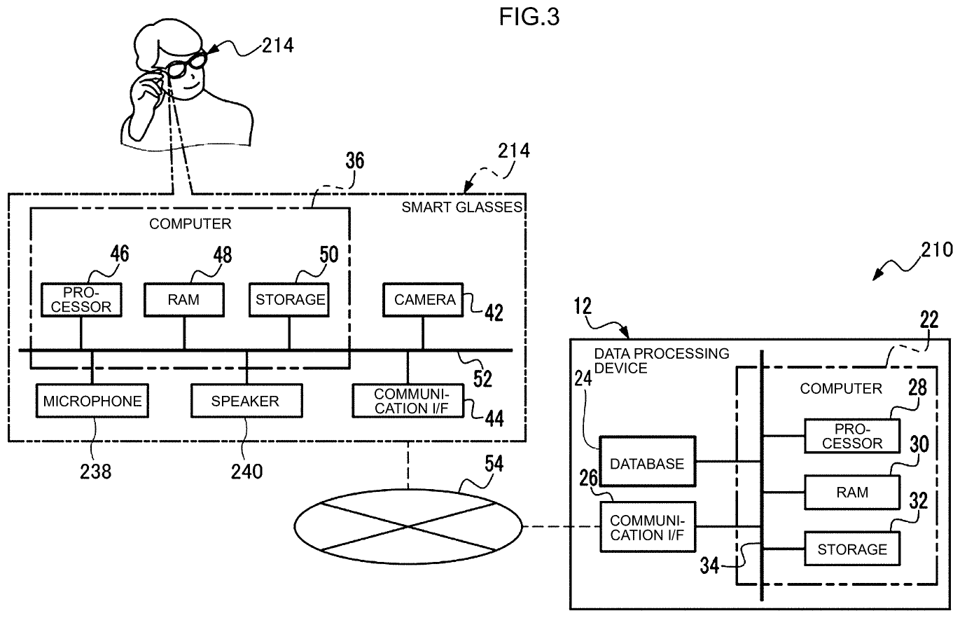

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

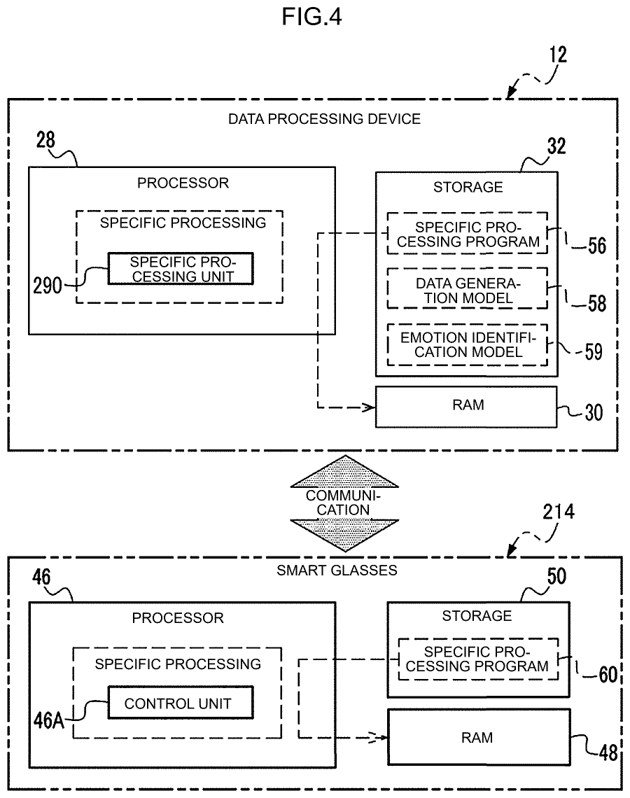

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the multiple elements including the above-described collection unit, storage unit, analysis unit, acquisition unit, provision unit, and execution support unit is implemented, for example, by at least one of the smart glasses 214 and the data processing apparatus 12. For example, the collection unit collects the company's energy consumption data in real time using the IoT device of the smart glasses 214. The storage unit stores the collected data in the cloud storage of the data processing apparatus 12. The analysis unit analyzes the energy consumption data stored in the cloud using generative AI by the specific processing unit 290 of the data processing apparatus 12. The acquisition unit acquires the latest energy trends and investment destination information by the specific processing unit 290 of the data processing apparatus 12. The provision unit provides the optimal renewable energy investment proposal to the company by the specific processing unit 290 of the data processing apparatus 12. The execution support unit provides specific steps for the company to execute the proposed investment plan by the specific processing unit 290 of the data processing apparatus 12. The correspondence between each unit and the device or control unit is not limited to the above examples and various modifications are possible.

### Third Embodiment

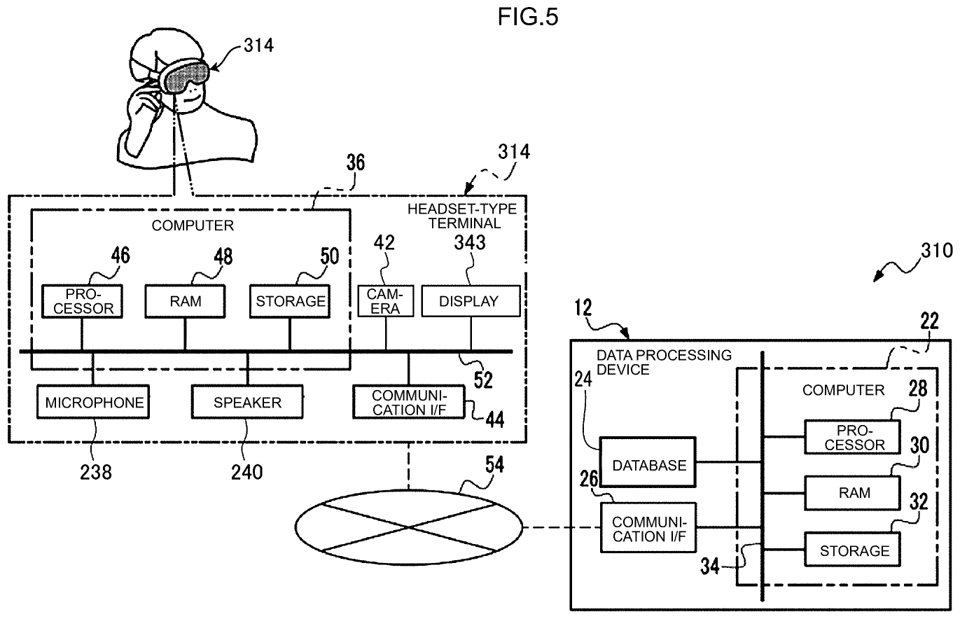

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

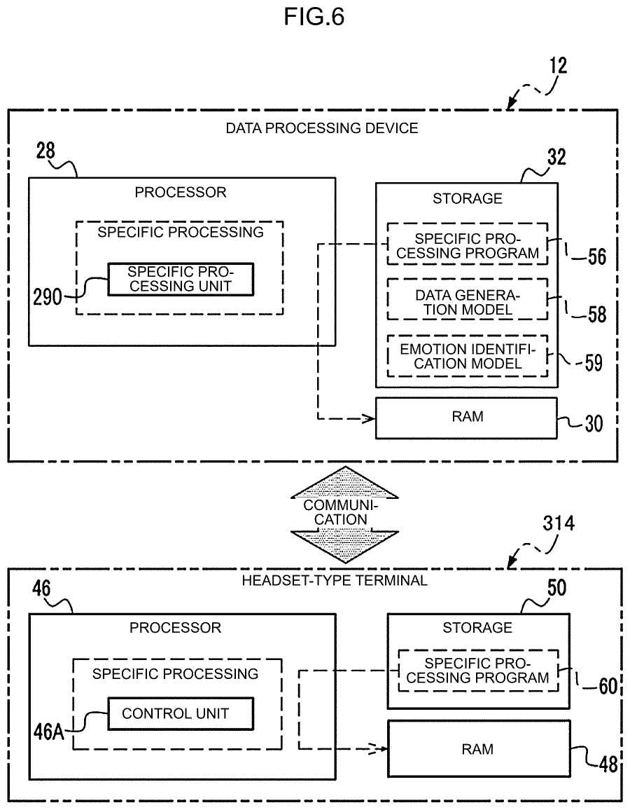

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the multiple elements including the above-described collection unit, storage unit, analysis unit, acquisition unit, provision unit, and execution support unit is implemented, for example, by at least one of the headset-type terminal 314 and the data processing apparatus 12. For example, the collection unit collects the company's energy consumption data in real time using the IoT device of the headset-type terminal 314. The storage unit stores the collected data in the cloud storage of the data processing apparatus 12. The analysis unit analyzes the energy consumption data stored in the cloud using generative AI by the specific processing unit 290 of the data processing apparatus 12. The acquisition unit acquires the latest energy trends and investment destination information by the specific processing unit 290 of the data processing apparatus 12. The provision unit provides the optimal renewable energy investment proposal to the company by the specific processing unit 290 of the data processing apparatus 12. The execution support unit provides specific steps for the company to execute the proposed investment plan by the specific processing unit 290 of the data processing apparatus 12. The correspondence between each unit and the device or control unit is not limited to the above examples and various modifications are possible.

### Fourth Embodiment

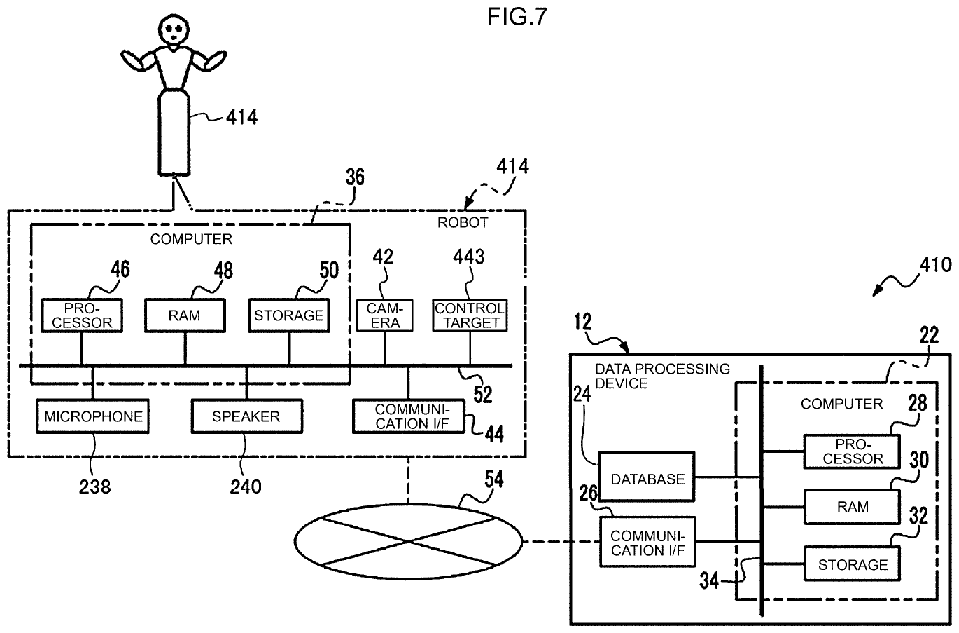

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

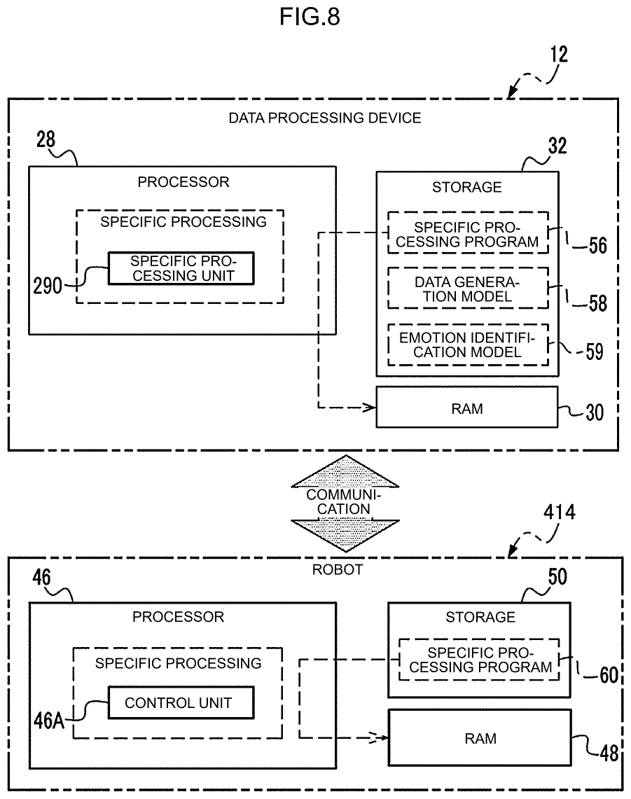

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the multiple elements including the above-described collection unit, storage unit, analysis unit, acquisition unit, provision unit, and execution support unit is implemented, for example, by at least one of the robot 414 and the data processing apparatus 12. For example, the collection unit collects the company's energy consumption data in real time using the IoT device of the robot 414. The storage unit stores the collected data in the cloud storage of the data processing apparatus 12. The analysis unit analyzes the energy consumption data stored in the cloud using generative AI by the specific processing unit 290 of the data processing apparatus 12. The acquisition unit acquires the latest energy trends and investment destination information by the specific processing unit 290 of the data processing apparatus 12. The provision unit provides the optimal renewable energy investment proposal to the company by the specific processing unit 290 of the data processing apparatus 12. The execution support unit provides specific steps for the company to execute the proposed investment plan by the specific processing unit 290 of the data processing apparatus 12. The correspondence between each unit and the device or control unit is not limited to the above examples and various modifications are possible.

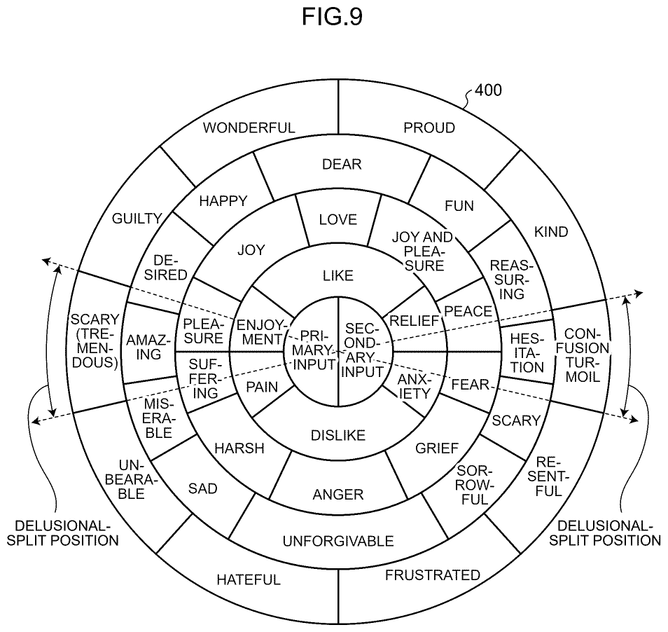

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

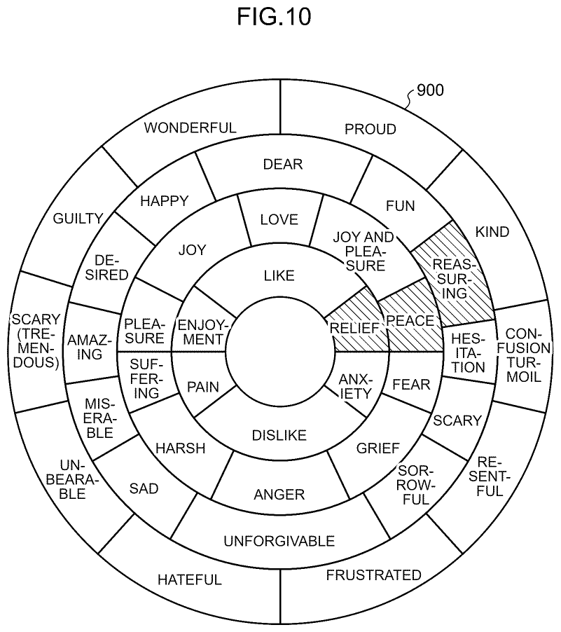

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### [Additional Note 1]

A system comprising: a collection unit that collects energy consumption data; a storage unit that stores the data collected by the collection unit in the Cloud; an analysis unit that analyzes the data stored by the storage unit; an acquisition unit that acquires the latest energy trends or investment destination information based on the data analyzed by the analysis unit; a provision unit that provides a renewable energy investment proposal based on the information obtained by the acquisition unit; and an execution support unit that provides specific steps for executing the investment proposal provided by the provision unit.

### [Additional Note 2]

The system according to Additional Note 1, wherein the collection unit collects energy consumption data in real time using IoT devices installed in factories or office buildings.

### [Additional Note 3]

The system according to Additional Note 1, wherein the analysis unit analyzes the energy consumption data stored in the Cloud using generative AI.

### [Additional Note 4]

The system according to Additional Note 1, wherein the acquisition unit acquires the latest energy trends or investment destination information using generative AI.

### [Additional Note 5]

The system according to Additional Note 1, wherein the provision unit provides renewable energy investment proposals by taking into account the company's energy consumption patterns or market trends using generative AI.

### [Additional Note 6]

The system according to Additional Note 1, wherein the execution support unit provides specific steps for the company to execute the proposed investment plan using generative AI.

### [Additional Note 7]

The system according to Additional Note 1, wherein the collection unit estimates the user's emotions and adjusts the timing of energy consumption data collection based on the estimated user emotions.

### [Additional Note 8]

The system according to Additional Note 1, wherein the collection unit changes the frequency of data collection based on specific time periods or seasons when collecting energy consumption data.

### [Additional Note 9]

The system according to Additional Note 1, wherein the collection unit adds a function to detect abnormal consumption patterns and issue alerts when collecting energy consumption data.

### [Additional Note 10]

The system according to Additional Note 1, wherein the collection unit estimates the user's emotions and determines the priority of data to be collected based on the estimated user emotions.

### [Additional Note 11]

The system according to Additional Note 1, wherein the collection unit collects data by taking into account geographic location information when collecting energy consumption data.

### [Additional Note 12]

The system according to Additional Note 1, wherein the collection unit integrates and collects data from other IoT devices when collecting energy consumption data.

### [Additional Note 13]

The system according to Additional Note 1, wherein the storage unit estimates the user's emotions and adjusts the data storage method based on the estimated user emotions.

### [Additional Note 14]

The system according to Additional Note 1, wherein the storage unit determines the storage priority based on the importance of the data at the time of data storage.

### [Additional Note 15]

The system according to Additional Note 1, wherein the storage unit applies different storage formats according to the type of data at the time of data storage.

### [Additional Note 16]

The system according to Additional Note 1, wherein the storage unit estimates the user's emotions and adjusts the data retention period based on the estimated user emotions.

### [Additional Note 17]

The system according to Additional Note 1, wherein the storage unit determines the storage priority based on the submission timing of the data at the time of data storage.

### [Additional Note 18]

The system according to Additional Note 1, wherein the storage unit adjusts the order of storage based on the relevance of the data at the time of data storage.

### [Additional Note 19]

The system according to Additional Note 1, wherein the analysis unit estimates the user's emotions and adjusts the analysis method based on the estimated user emotions.

### [Additional Note 20]

The system according to Additional Note 1, wherein the analysis unit refers to past data to predict current data during analysis.

### [Additional Note 21]

The system according to Additional Note 1, wherein the analysis unit applies different analysis algorithms for each data category during analysis.

### [Additional Note 22]

The system according to Additional Note 1, wherein the analysis unit estimates the user's emotions and determines the analysis priority based on the estimated user emotions.

### [Additional Note 23]

The system according to Additional Note 1, wherein the analysis unit determines the analysis priority based on the submission timing of the data during analysis.

### [Additional Note 24]

The system according to Additional Note 1, wherein the analysis unit adjusts the order of analysis based on the relevance of the data during analysis.

### [Additional Note 25]

The system according to Additional Note 1, wherein the acquisition unit estimates the user's emotions and determines the priority of information to be acquired based on the estimated user emotions.

### [Additional Note 26]

The system according to Additional Note 1, wherein the acquisition unit updates the latest energy trends in real time during acquisition.

### [Additional Note 27]

The system according to Additional Note 1, wherein the acquisition unit evaluates the reliability of investment destination information during acquisition and preferentially acquires highly reliable information.

### [Additional Note 28]

The system according to Additional Note 1, wherein the acquisition unit estimates the user's emotions and adjusts the display method of the information to be acquired based on the estimated user emotions.

### [Additional Note 29]

The system according to Additional Note 1, wherein the acquisition unit acquires information by taking into account geographic location information during acquisition.

### [Additional Note 30]

The system according to Additional Note 1, wherein the acquisition unit integrates and acquires information from other data sources during acquisition.

### [Additional Note 31]

The system according to Additional Note 1, wherein the provision unit estimates the user's emotions and adjusts the expression method of the investment proposal to be provided based on the estimated user emotions.

### [Additional Note 32]

The system according to Additional Note 1, wherein the provision unit adjusts the level of detail of the investment proposal based on the company's energy consumption pattern at the time of provision.

### [Additional Note 33]

The system according to Additional Note 1, wherein the provision unit proposes different investment proposals according to the industry type or scale of the company at the time of provision.

### [Additional Note 34]

The system according to Additional Note 1, wherein the provision unit estimates the user's emotions and adjusts the length of the investment proposal to be provided based on the estimated user emotions.

### [Additional Note 35]

The system according to Additional Note 1, wherein the provision unit determines the priority of provision based on the submission timing of the investment proposal at the time of provision.

### [Additional Note 36]

The system according to Additional Note 1, wherein the provision unit adjusts the order of provision based on the relevance of the investment proposal at the time of provision.

### [Additional Note 37]

The system according to Additional Note 1, wherein the execution support unit estimates the user's emotions and adjusts the method of execution support based on the estimated user emotions.

### [Additional Note 38]

The system according to Additional Note 1, wherein the execution support unit selects the optimal support method by referring to the company's past investment history during execution support.

### [Additional Note 39]

The system according to Additional Note 1, wherein the execution support unit customizes the means of support based on the company's current financial situation during execution support.

### [Additional Note 40]

The system according to Additional Note 1, wherein the execution support unit estimates the user's emotions and determines the priority of execution support based on the estimated user emotions.

### [Additional Note 41]

The system according to Additional Note 1, wherein the execution support unit selects the optimal support method by taking into account the company's geographic location information during execution support.

### [Additional Note 42]

The system according to Additional Note 1, wherein the execution support unit analyzes the company's social media activities during execution support and proposes means of support.

What is claimed is:

1. A system comprising: a collection unit that collects energy consumption data; a storage unit that stores the data collected by the collection unit in the Cloud; an analysis unit that analyzes the data stored by the storage unit; an acquisition unit that acquires the latest energy trends or investment destination information based on the data analyzed by the analysis unit; a provision unit that provides a renewable energy investment proposal based on the information obtained by the acquisition unit; and an execution support unit that provides specific steps for executing the investment proposal provided by the provision unit.

2. The system according to claim 1, wherein the collection unit collects energy consumption data in real time using IoT devices installed in factories or office buildings.

3. The system according to claim 1, wherein the analysis unit analyzes the energy consumption data stored in the Cloud using generative AI.

4. The system according to claim 1, wherein the acquisition unit acquires the latest energy trends or investment destination information using generative AI.

5. The system according to claim 1, wherein the provision unit provides renewable energy investment proposals by taking into account the company's energy consumption patterns or market trends using generative AI.

6. The system according to claim 1, wherein the execution support unit provides specific steps for the company to execute the proposed investment plan using generative AI.

7. The system according to claim 1, wherein the collection unit estimates the user's emotions and adjusts the timing of energy consumption data collection based on the estimated user emotions.

8. The system according to claim 1, wherein the collection unit changes the frequency of data collection based on specific time periods or seasons when collecting energy consumption data.
